(19) United States
(12) Patent Application Publication
(10) Pub. No.: US 2023/0146793 A1
(43) Pub. Date: May 11, 2023

(54) Drainline Cannon

(71) Applicant: Istvan Nagy, Vero Beach, FL (US)

(72) Inventor: Istvan Nagy, Vero Beach, FL (US)

(21) Appl. No.: 18/049,364

(22) Filed: Oct. 25, 2022

Related U.S. Application Data
(60) Provisional application No. 63/276,123, filed on Nov. 5, 2021.

(51) Int. Cl. B08B 9/032

(52) U.S. Cl. CPC B08B 9/0321; F24F 2221/225; E03C 1/304

(57) ABSTRACT

The present invention provides an apparatus that comprises a main round cylinder, a round plate, a piston rod inserted into the main round cylinder, a handle mounted to one end of the piston rod, a nipple tube attached to the round plate, and an insert mounted to one end of the piston rod.

### FIELD OF THE INVENTION

The present invention relates generally to HVAC and plumbing system maintenance. More specifically, an apparatus used to clean HVAC equipment and plumbing systems.

### BACKGROUND OF THE INVENTION

HVAC refers to Heating, Ventilation and Air Conditioning equipment, which incorporates a control system to regulate the operation of a heating and/or air conditioning system. An integral part of this system are the ducts, which are passages used to deliver or remove air throughout the system. These ducts commonly attract a buildup of sentiments such as dust, cobwebs, hair, debris, etc., which can clog the ducts or circulate harmful containments throughout the building over time.

The present invention is an apparatus which can be used to clean HVAC or other related equipment.

### SUMMARY

In accordance with the present invention, a novel apparatus is provided. The present invention comprises a main round cylinder, a round plate, a piston rod inserted into the main round cylinder, a handle mounted to one end of the piston rod, a nipple tube attached to the round plate, and an insert mounted to one end of the piston rod.

In one embodiment, the present invention includes a main round cylinder with a first open end and a second open end, the second open end attached to a round plate with a hole defined axially and centrally through the round plate; a piston rod inserted into the main round cylinder; a handle mounted to one end of the piston rod; a nipple tube attached to the round plate; and an insert mounted to one end of the piston rod.

In some embodiments, the main round cylinder includes a clear transparent tube design to makes it especially easy for the user to see the results.

### BRIEF DESCRIPTION OF THE DRAWINGS

FIG. 1 is an illustration of one embodiment of the present invention.

FIG. 2 is a side view of one embodiment of the present invention.

FIG. 3 is a side view of a piston rod of the present invention.

FIG. 4 is an illustration showing a main round cylinder of the present invention.

FIG. 5 is an illustration showing a piston space placed in the main round cylinder of the present invention.

FIG. 6 is an illustration showing a main round cylinder connected to a nipple tube of the present invention.

FIG. 7 is an illustration of the piston rod being inserted into the main round cylinder of the present invention.

### DETAIL DESCRIPTIONS OF THE INVENTION

All illustrations of the drawings are for the purpose of describing selected versions of the present invention and are not intended to limit the scope of the present invention.

The present invention, herein referred to as “Drainline Cannon”, is an apparatus intended to be used as an efficient device to clean clogged, common HVAC and household drain lines including but not limited to AC drain lines, Heat Pump drain lines, sink drains, shower drains, toilet drains etc.

Drainline Cannon utilizes air and water pressure to remove clogs, clean and maintain drain lines effectively and efficiently.

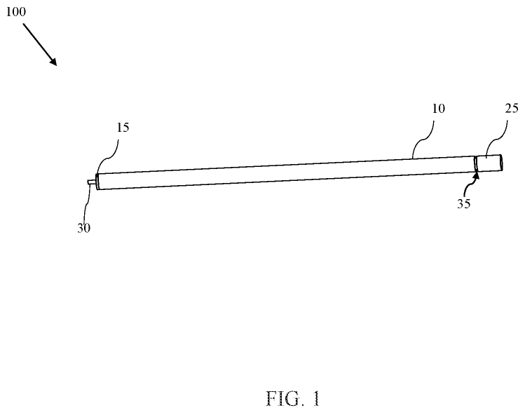

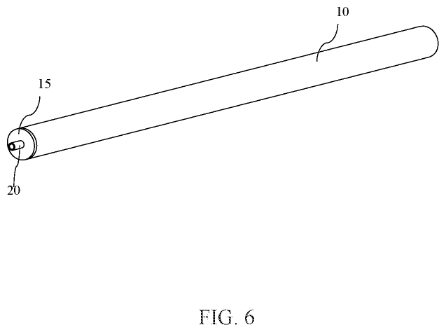

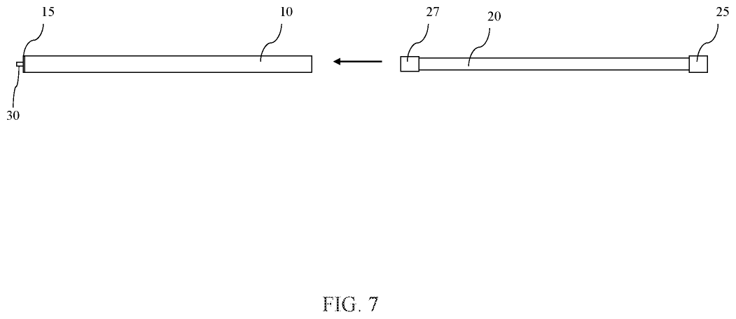

As shown in FIGS. 1-7, the present invention provides an apparatus 100 comprising: a main round cylinder 10, a round plate 15, a piston rod 20, a handle 25, a nipple tube 30, and an insert 27.

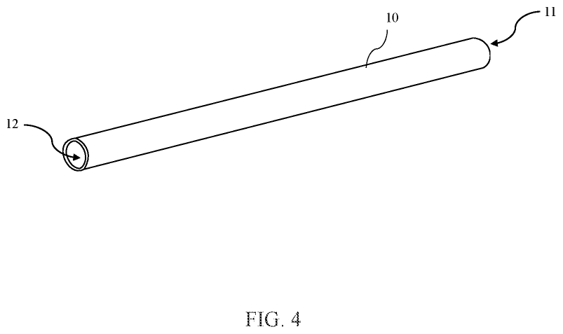

As shown in FIG. 4, in some embodiments, the main round cylinder 10 may include a first open end 11 and a second open end 12, the second open end 12 can be attached to the round plate 15 having a hole defined axially and centrally through the round plate 15.

The piston rod 20 may be configured to be inserted into the main round cylinder 10. The handle 25 can be connected to one end of the piston rod 20.

The nipple tube 30 can be attached to the round plate 15. In some embodiments, the nipple tube 30 may include a passage extending along a length of the nipple tube 30, wherein the passage is connected to the hole of the round plate 30.

The insert 27 can be mounted to one end of the piston rod 20. In some embodiments, the insert 27 can be an optional component and the apparatus 100 may not include the insert 27. The main round cylinder 10 is a circular and cylindrical tube.

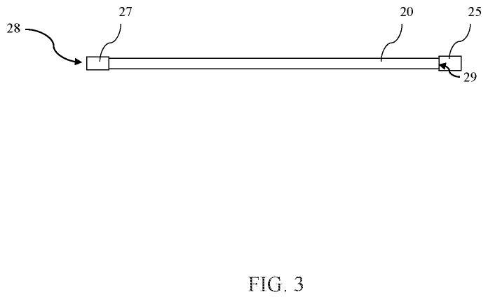

As shown in FIG. 3, the piston rod 20 may include a distal end 28 and a proximal end 29. The piston rod 20 can be inserted into the main round cylinder 10 through the first open end 11 of the main round cylinder 10. The insert 27 may be mounted in the area near the the distal end 28 of the piston rod 20.

The insert 27 can be configured to be moved reciprocally in the main round cylinder 10. When the piston rod 20 is fully inserted in the main round cylinder 10, the proximal end 29 of the piston rod 20 may extend through the first open end 11. The handle 25 can be mounted to the proximal end 29.

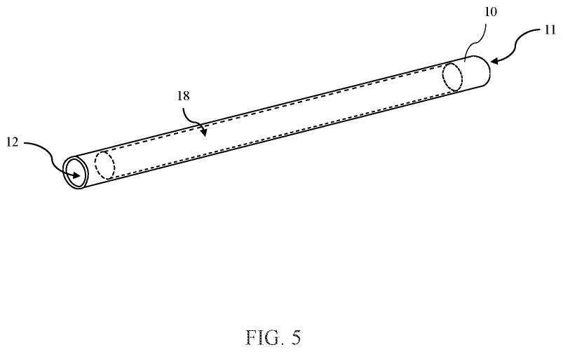

In one embodiment, as shown in FIG. 5, a piston space 18 can be arranged in the interior of the main round cylinder 10 and the insert 27 can be slidably connected in the piston space 18.

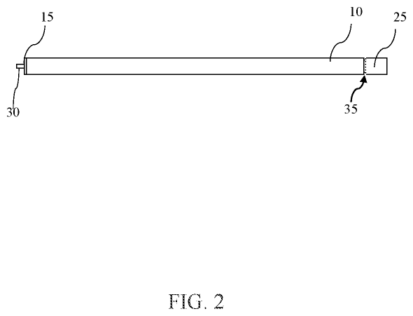

In some embodiments, when the piston rod 20 is fully inserted in the main round cylinder 10, the present invention may include a gap 35 between the main round cylinder 10 and the handle 25, as shown in FIG. 1 and FIG. 2.

The present invention may be made from any suitable material, including plastic, elastomer, or metal. In some embodiments, the main round cylinder 10 can be made from transparent plastic.

In use a user of the present invention (Drainline Cannon) moves the piston rod 20 inward, creating air or water pressure. The direction of the piston rod 20 can be reversed, creating negative pressure.

In some embodiments, the main round cylinder 10, may include a clear transparent tube to makes it especially easy for the user to see the results.

Although the invention has been explained in relation to its preferred embodiment, it is to be understood that many other possible modifications and variations can be made without departing from the spirit and scope of the invention.

What is claimed is:

1. An apparatus comprising:
a main round cylinder with a first open end and a second open end, the second open end attached to a round plate with a hole defined axially and centrally through the round plate;
a piston rod inserted into the main round cylinder;
a handle mounted to one end of the piston rod; and
a nipple tube attached to the round plate.

2. The apparatus as claimed in claim 1, wherein the main round cylinder includes a clear transparent tube.

3. The apparatus as claimed in claim 1, wherein the nipple tube includes a passage extending along a length of the nipple tube.

4. The apparatus as claimed in claim 3, wherein the passage is connected to the hole of the round plate.

5. The apparatus as claimed in claim 1, wherein the apparatus includes a gap between the main round cylinder and the handle.

6. The apparatus as claimed in claim 1, wherein the apparatus further includes an insert mounted to one end of the piston rod.

7. An apparatus comprising:
a main round cylinder having a piston space, the main round cylinder includes a first open end and a second open end, the second open end attached to a round plate with a hole defined axially and centrally through the round plate;
a piston rod inserted into the main round cylinder;
a handle mounted to one end of the piston rod;
a nipple tube attached to the round plate; and
an insert mounted to one end of the piston rod.

8. The apparatus as claimed in claim 7, wherein the main round cylinder includes a clear transparent tube.

9. The apparatus as claimed in claim 7, wherein the nipple tube includes a passage extending along a length of the nipple tube.

10. The apparatus as claimed in claim 9, wherein the passage is connected to the hole of the round plate.

11. The apparatus as claimed in claim 7, wherein the insert is slidably connected in the piston space.

12. The apparatus as claimed in claim 7, wherein the apparatus includes a gap between the main round cylinder and the handle.

13. The apparatus as claimed in claim 7, wherein the apparatus is made from plastic.

14. An apparatus comprising:
a main round cylinder having a piston space, the main round cylinder includes a first open end and a second open end, the second open end attached to a round plate with a hole defined axially and centrally through the round plate;
a piston rod inserted into the main round cylinder;
a handle mounted to one end of the piston rod;
a nipple tube attached to the round plate; and
an insert mounted to one end of the piston rod, wherein the insert is slidably connected in the piston space.

15. The apparatus as claimed in claim 14, wherein the main round cylinder includes a clear transparent tube.

16. The apparatus as claimed in claim 14, wherein the nipple tube includes a passage extending along a length of the nipple tube.

17. The apparatus as claimed in claim 16, wherein the passage is connected to the hole of the round plate.

18. The apparatus as claimed in claim 14, wherein the apparatus includes a gap between the main round cylinder and the handle.

19. The apparatus as claimed in claim 14, wherein the apparatus is made from plastic.

20. The apparatus as claimed in claim 14, wherein the main round cylinder is made from transparent plastic.
